(19) United States
(12) Patent Application Publication
(10) Pub. No.: US 2022/0100464 A1
(43) Pub. Date: Mar. 31, 2022

(54) METHODS AND SYSTEMS FOR EXECUTION OF VOICE COMMANDS

(71) Applicant: SAMSUNG ELECTRONICS CO., LTD., Suwon-si (KR)

(72) Inventors: Mani Prakash, Bangalore (IN); Shiva Murthy Busetty, Bangalore (IN); Srinivasa Rao Payyavula, Bangalore (IN); Satyam Bharadwaj, Bangalore (IN); Manoj Devender Goud Nanumasa, Bangalore (IN); Ramaswamy Srinivasa Ramanujam, Bangalore (IN)

(21) Appl. No.: 17/336,689

(22) Filed: Jun. 2, 2021

(30) Foreign Application Priority Data
Sep. 28, 2020 (IN) 202041042102

(51) Int. Cl. G06F 3/16; G06F 1/3212; G06F 1/329

(52) U.S. Cl. CPC G06F 3/167; G10L 2015/223; G06F 1/329; G06F 1/3212

(57) ABSTRACT

Methods and systems for energy efficient execution of voice commands are disclosed. On receiving a command, based on an action specified by, and the intent of, the command, IoT devices, in the IoT environment, capable of executing the command are determined. Various embodiments determine natural alternative(s) and combinations of natural alternative(s) and IoT devices for executing the command. Individual ranks are assigned to each of the IoT devices, the natural alternative(s), and combinations of natural alternative(s) and IoT devices, based on power consumption of the IoT devices and at least one ecological factor affecting the user experience when the IoT devices and/or the natural alternative(s) may be used in executing the command. An IoT device, a natural alternative, or a combination of an IoT device and a natural alternative may be selected to execute the command, based on the selected IoT device and/or the natural alternative having the highest rank.

### CROSS-REFERENCE TO RELATED APPLICATION

This application claims priority under 35 U.S.C. § 119 to Indian Complete Patent Application Serial No. 202041042102, filed on Sep. 28, 2020, in the Indian Intellectual Property Office, the disclosure of which is incorporated by reference herein in its entirety.

### BACKGROUND

### Field

The disclosure relates to managing Internet of Things (IoT) devices using voice commands, and for example, to methods and systems for executing voice commands using IoT devices such that command execution is performed in an energy efficient manner and user experience is enhanced.

### Description of Related Art

Currently, voice assistants are configured to detect voice commands from users, and perform actions that lead to the execution of the commands. A voice assistant can receive a voice command and determine Internet of Things (IoT) devices, within the range of the voice assistant, which are capable of performing tasks or actions that facilitates the execution of the voice command. For example, if a voice command issued by a user is “play music”, then the voice assistant can turn on the music player. In case the user specifies a particular IoT device, in a voice command, for performing a task, the voice assistant can direct the IoT device to perform the task. For example, if the voice command is “switch on the washing machine”, then the voice assistant can turn on the washing machine.

However, arbitrarily selecting an IoT device or using the IoT device specified in the voice command, for executing the user command, may not be appropriate, particularly in terms of providing an enhanced user experience or efficient resource utilization. In an example, consider the voice command is “turn on the geyser”. In this scenario, the voice assistant is likely to turn the geyser (e.g., water heater) on. However, if the weather is sunny, and if there are alternative means available for executing the user command in an energy efficient manner, then turning on the geyser may not be appropriate.

In another example, consider the voice command is “turn on the washing machine”. The settings of the washing machine, such as dryer duration and dryer Revolution per Minute (RPM), are likely to be set to a predefined level. If the weather is sunny and if the wind speed is likely to be low at the completion of the washing procedure, then the dryer RPM and the dryer duration needs to be reduced for providing a satisfactory or enhanced user experience.

### SUMMARY

Embodiments of the disclosure provide methods and systems for enabling a voice assistant to facilitate execution of user commands in an Internet of Things (IoT) environment, wherein the execution allows efficient utilization of energy (power) and resources (IoT devices) used for executing the user commands and providing an enhanced user experience.

Embodiments of the disclosure provide methods and systems that determine IoT devices, in the IoT environment, which are capable of executing a voice command issued by a user, wherein one of the IoT devices may be explicitly stated in the voice command.

Embodiments of the disclosure provide methods and systems that determine IoT devices, in the IoT environment, that can utilize natural means for executing the voice command issued by the user.

Embodiments of the disclosure provide methods and systems that assign individual ranks to each of the determined IoT devices based on power consumption of the determined IoT devices and at least one ecological factor affecting the user experience when the determined IoT devices utilize natural means for executing the voice command.

Embodiments of the disclosure provide methods and systems that adjust the settings of the determined IoT devices based on at least one of previous usage pattern, contextual factors, ecological factors, etc., to ensure that actual intent of the user, for which the voice command was issued, is satisfied.

Embodiments of the disclosure provide methods and systems that display the determined IoT devices, which can be used for executing the user command, wherein the determined IoT devices are arranged in a list, wherein the arrangement is based on individual ranks assigned to each of the determined IoT devices.

Accordingly, example embodiments provide methods and systems for enabling energy efficient execution of user commands using Internet of Things (IoT) devices in an IoT environment. Example embodiments include receiving a voice command from a user. The voice command may include an action to be performed by an IoT device. Example embodiments include determining other IoT devices in the IoT environment, which are capable of performing the action specified in the voice command. Example embodiments include deriving the intent of the user to determine the other IoT devices capable of performing the action specified in the voice command.

If the voice command is expressing the intent of the user without explicitly specifying the action to be performed, then example embodiments include analyzing the intent. In an example embodiment, the intent analysis can be performed using at least one natural language understanding technique. Based on the analysis, example embodiments include mapping the intent to an action. If the voice command does not explicitly specify an IoT device to perform the action, example embodiments include determining IoT devices in the IoT environment that are capable of performing the action.

Once the IoT devices capable of performing the action have been determined, example embodiments include determining IoT device that can utilize at least one natural means for performing the action. Example embodiments include generating flows for performing the action, wherein each flow comprises either at least one IoT device capable of performing the action or at least one of IoT device that utilize at least one natural alternatives to perform the action.

Example embodiments include assigning ranks to each of the IoT devices. In an example embodiment, the respective ranks can be assigned based on at least one of: the amount of power that is likely to be consumed if the IoT devices are used for performing the action; and at least one ecological factor that is capable of affecting the user experience when the IoT devices utilizing natural alternatives are used for performing the action. The amount of power that is likely to be consumed, if IoT devices are utilized for executing the voice command, depends on previous usage patterns of the IoT devices and the power ratings of the IoT devices.

Example embodiments include displaying the IoT devices that are capable of performing the action, in the form of a list. The list of IoT devices can be displayed as options that are available to the user to execute the voice command. The IoT devices are placed in the list in a descending order in terms of the respective ranks assigned to the IoT devices. The IoT device at the top of the list is having the highest rank. Once the user selects one of the options, example embodiments include adjusting the settings of the selected IoT devices based on at least one of previous usage pattern, contextual factors, ecological factors, and so on.

These and other aspects of the various example embodiments disclosed herein will be better appreciated and understood when considered in conjunction with the following description and the accompanying drawings. It should be understood, however, that the following descriptions, while describing various example embodiments and numerous details thereof, are given by way of illustration and not of limitation. Many changes and modifications may be made within the scope of the example embodiments herein without departing from the spirit thereof, and the embodiments herein include all such modifications.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an example voice assistant configured to manage execution of user voice commands in an energy efficient manner, in an Internet of Things (IoT) environment, according to various embodiments;

FIG. 2 is a flowchart illustrating an example method for enabling the voice assistant to facilitate energy efficient execution of user commands using the IoT devices in the IoT environment, according to various embodiments;

FIG. 3 is a diagram illustrating an example use-case scenario illustrating the generation of flows for providing alternatives to a user for obtaining hot water, according to various embodiments;

FIG. 4 is a diagram illustrating an example use-case scenario illustrating the generation of flows for providing alternatives to a user for venting smoke from a kitchen, according to various embodiments;

FIG. 5 is a diagram illustrating an example use-case scenario illustrating the generation of flows for providing alternatives to a user for increasing the brightness of a room, according to various embodiments;

FIG. 6 is a diagram illustrating example selection of solar water heater by the user for obtaining hot water, according to various embodiments;

FIG. 7 is a diagram illustrating example selection of a smart window for improving air quality of a room, according to various embodiments; and

FIG. 8 is a diagram illustrating example selection of drapes (e.g., window blind) for increasing the brightness of a room, according to various embodiments.

### DETAILED DESCRIPTION

Various example embodiments and various features and advantageous details thereof are explained more fully with reference to the various example non-limiting embodiments illustrated in the accompanying drawings and described in the following disclosure. Descriptions of well-known components and processing techniques may be omitted so as to not unnecessarily obscure the embodiments herein. The examples used herein are intended merely to facilitate an understanding of ways in which the various example embodiments herein may be practiced and to further enable those of skill in the art to practice the various example embodiments herein. Accordingly, the examples should not be construed as limiting the scope of the embodiments herein.

Example embodiments herein disclose methods and systems for enabling a voice assistant to manage execution of commands issued by users in an Internet of Things (IoT) environment. The voice assistant can facilitate the execution of the user commands such that there is an efficient utilization of the energy used for executing the user commands and an enhanced user experience is provided to the users. Example embodiments include analyzing a user command and determining whether the user had specified, in the user command, at least one of the action to be performed and the IoT device to be used for performing the action. If the action to be performed and the IoT device to be used for performing the action have been specified in the user command, then example embodiments may include determining other IoT devices in the IoT environment, which are capable of executing the user command. If the action to be performed and the IoT device to be used for performing the action has not been specified in the user command, then example embodiments may include determining an action to be performed based on the intent of the user expressed in the user command. Example embodiments may include detecting at least one IoT device in the IoT environment, which is capable of performing the action for executing the user command.

Example embodiments may include determining at least one IoT device that utilizes natural alternative(s) (as used herein, the terms “natural means” and “natural alternative” may be used interchangeably and may refer, for example, to natural systems and/or methods) for executing the user command. The at least one IoT device, which utilizes the natural alternative for executing the user command, may perform actions that are same/similar to the IoT devices that have been specified in the user command or the at least one IoT device determined through the analysis of the user command. Example embodiments include assigning ranks to each of the at least one IoT device determined to be capable of executing the user command, and the at least one IoT device that utilizes natural alternative for executing the user command. The ranks may, for example, be assigned based on power consumption of the IoT devices and at least one ecological factor affecting the user experience when execution of the user command depends on the natural means.

Example embodiments include displaying a list comprising of the at least one IoT device determined to be capable of performing the action for executing the user command, and the at least one IoT device that utilizes natural alternative(s) for executing the user command. The determined at least one IoT device, and the at least one IoT device utilizing the at least one natural alternative, may be displayed in the list in a descending order, based on the respective assigned ranks. The user can select an IoT device from the list, to execute the user command. Example embodiments include adjusting the settings of the selected IoT device based on at least one of previous usage pattern, contextual factors, and ecological factors, in order to ensure that actual intent of the user is satisfied, and the user experience is enhanced.

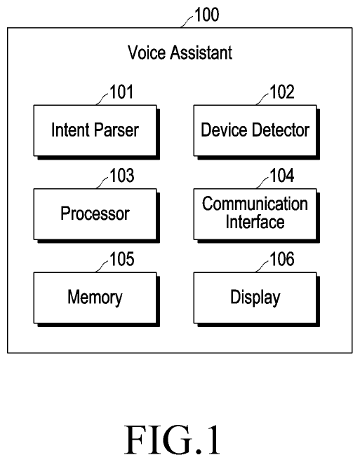

Referring now to the drawings, and more particularly to FIGS. 1 through 8, where similar reference characters denote like corresponding elements throughout the figures, there are illustrated and described various example embodiments.

FIG. 1 is a block diagram illustrating an example configuration of a voice assistant 100 configured to manage execution of user commands in an energy efficient manner, in an IoT environment, according to various example embodiments. In an embodiment, the voice assistant 100 can be included in an IoT device, in the IoT environment, acting as a central controller. In an embodiment, the voice assistant 100 may be a standalone device. The voice assistant 100, being a part of the IoT environment (ecosystem), can interact with other IoT devices in the IoT environment. Examples of IoT devices in IoT environment may include, but are not limited to, a smart phone, a laptop, a tablet, a wearable device, a fridge, a geyser, an air conditioner, a chimney, a washing machine, a music player, a bulb, a fan, a television, a vehicle infotainment system, and so on.

As depicted in FIG. 1, the voice assistant 100 includes an intent parser (e.g., including circuitry and/or executable program elements) 101, a device detector (e.g., including circuitry and/or executable program elements) 102, a processor (e.g., including processing circuitry) 103, a communication interface (e.g., including communication circuitry) 104, a memory 105, and a display 106. In an embodiment, the processor 103 may include Artificial Intelligence (AI) capability. The voice assistant 100 can interact with a remote device, such as a server, which can store data pertaining to the IoT devices in the IoT environment. The voice assistant 100 can fetch information, from the remote device, which may be relevant to the IoT devices in the IoT environment.

When a user issues a voice command, the intent parser 101 can capture the voice command. The user may specify, through the voice command, an action to be performed. The user may also specify an IoT device, using which the specified action can be performed. As an example, the user command may be “switch on the light”. The intent parser 101 may include various circuitry and/or executable program elements that can derive the action that needs to be performed. In this instance, the intent parser 101 can derive that the intended action is ‘switch on the light’. The intent parser 101 can provide the derived action to the device detector 102. If the IoT environment is having more than IoT device capable of performing the intended action, e.g., if multiple IoT devices capable of providing light are available, the device detector 102 can determine at least one IoT device in the IoT environment (where the user is present), which is capable of performing the intended action. In an example, the device detector 102 may determine a Light Emitting Diode (LED) and a mercury light as the sources of light.

The intent parser 101 can store the voice command in the memory 105. If the same command is received again, the intent parser need not derive the intended action again, and the device detector 102 can present the same IoT devices that are capable of providing light (LED and mercury light).

In an example the voice command may be “increase the brightness”. The voice command is captured by the intent parser 101 and it is determined that this command has been issued for the first time. In this scenario, the intent parser 101 can determine the intent of the user. In an embodiment, the intent parser 101 can utilize natural language understanding techniques to derive the intent. In an example the derived intent may be ‘light-up the ambience’. The intent parser 101 can provide the derived intent to the device detector 102. The device detector 102 can determine at least one IoT device in the IoT environment, which is capable of providing light. Considering the IoT environment to be same as the previous example, the sources of light are the LED, and the mercury light.

Consider an example in which the user had specified an IoT device and the action to be performed by the IoT device, in the voice command. In an example, the voice command may be “Turn on the AC”. The IoT device specified in the voice command is ‘AC’ and the action to be performed is ‘turning on the AC’. The intent parser 101 can provide the command to the device detector 102. In this scenario, the device detector 102 may include various circuitry and/or executable program elements and may detect at least one IoT device in the IoT environment that is capable of performing the actions which can be performed by the AC. For example: the AC can cool the ambience and can bring fresh air to the ambience. The device detector 102 detects at least one IoT device that is capable of at least one of cooling the air and bringing fresh air to the ambience. For example, the detected IoT devices can be an air cooler and an air purifier. In an embodiment, the memory 105 can include the list of IoT devices in the IoT environment and the corresponding actions that can be performed by each of the IoT devices in the IoT environment.

The processor 103 may include various processing circuitry and can obtain the at least one IoT device capable of executing the voice command (fulfill the intent of the user or perform the action specified in the voice command) from the device detector 102. The processor 103 can determine at least one IoT device that utilizes at least one natural means for executing the voice command. The processor 103 can determine the at least one IoT device utilizing the natural alternative(s) on verifying that the effect of applying the natural alternative, to execute the voice command, is same as the effect of utilizing the at least one IoT device capable of executing the voice command. Consider that the voice command issued by the user is “increase the brightness”. In this scenario, the IoT device that utilizes a natural alternative (determined by the processor 103) for increasing the brightness of the ambience, may, for example, be ‘a smart window blind’.

The processor 103 can determine a combination of an IoT device capable of executing the voice command and an IoT device that utilizes a natural alternative for executing the voice command. If the voice command issued by the user is “turn on the AC”, the IoT device that utilizes natural alternative may, for example, be ‘smart window’, and the IoT device capable of executing the voice command can be an ‘air purifier’. The option is ‘opening the window’ and ‘switching on the air purifier’. The processor 103 can determine the combination on verifying that the effect of applying the combination, to execute the voice command, is same as the effect of utilizing the at least one IoT device capable of executing the voice command.

IoT devices, which utilize natural alternative(s) for executing the voice command, can be used if at least one ecological factor supports utilizing the natural alternative.

The device detector 102 is configured to determine alternative IoT devices (not specified in the voice command) and the processor 103 is configured to determine IoT devices that utilize natural alternative(s), in order to reduce the power consumption involved in executing the voice command. Executing the voice command using the alternative IoT devices reduces the power consumption involved in executing the voice command. The IoT devices that utilize natural alternative(s) can be used for executing the voice command without expediting energy/power.

In an embodiment, the processor 103 can obtain the ecological factors using sensors (such as air quality detection sensors, weather detection sensors, luminosity detection sensors, temperature detection sensors, and so on). In an embodiment, certain ecological factors (such as weather) can be obtained from the Internet. The consideration of the at least one ecological factor, by the processor 103, for determining the IoT devices, which utilize the natural alternative for executing the voice command, is based on the context of the voice command.

For example, if the voice command is “increase the brightness”, one of the IoT devices, which utilizes the natural alternative for executing the voice command, can be a smart window, as opening the smart window can increase the brightness. The ecological factors that will be considered for determining the feasibility of using the natural alternative for executing the voice command may include, but is not limited to, weather conditions, time of the day, the air quality, and so on. The feasibility can indicate whether the user intent can be accomplished using the IoT devices, which utilizes the natural alternative. In an embodiment, the feasibility may, for example, be defined using an ecological index, wherein the ecological index can be in a range from 0-1, with 0 defining the highest feasibility and 1 defining the lowest feasibility.

Considering the example, if the weather is overcast, chilly, or warm, then opening the smart window may not be feasible. On the other hand, if the weather is sunny and bright, and the outside temperature is close to the room temperature, then it may be feasible to open the smart window. If the time of the day is late evening, early morning, or night, then it is not feasible to open the smart window. On the other hand, if it is daytime, the temperature is mild, and it is not windy, the smart window can be opened. If the air quality is above a predefined threshold, and if the weather and time of the day support the feasibility of opening the window, then the smart window can be opened. On the other hand, if the air quality is below the predefined threshold, opening the smart window will not be considered feasible, even if the weather and time of the day support the feasibility of opening the window.

In an example, wherein the voice command is “turn on the AC”, a combination of an IoT device utilizing a natural alternative and an IoT device capable of executing the voice command can be determined. The IoT device utilizing a natural alternative for executing the voice command can be a smart window and the IoT device capable of executing the voice command may, for example, be an air purifier. The smart window can be opened and the air purifier can be turned on to execute the voice command. Opening the smart window can increase the freshness of the ambience and the air purifier can contribute to the freshness and prevent impure air from entering into the user ambience. The ecological factors that will be considered for determining the feasibility of utilizing the combination of IoT devices may include, but is not limited to, weather conditions, temperature, air quality, and so on.

For example, if the weather is overcast and/or mild then the combination of IoT devices may be feasible. On the other hand, if the weather is sunny and warm, and the temperature is high, then the combination of IoT devices may not be feasible. If the air quality is above or close to a predefined threshold, if the weather supports the feasibility of opening the window, and if the air purifier is sufficient to improve the air quality, then the combination of IoT devices may be feasible for executing the voice command. On the other hand, if the air quality is below the predefined threshold, then the combination of IoT devices may not be feasible for executing the voice command.

The processor 103 can generate flows, which are available for executing the voice command. Each flow is represented by either of an IoT device capable of executing the voice command, an IoT device utilizing a natural alternative for executing the voice command, or a combination of an IoT device capable of executing the voice command and an IoT device utilizing a natural alternative for executing the voice command. Consider that the voice command is “increase the brightness”. In this scenario, the available flows are ‘smart window’ (utilizing natural alternative(s) for executing the voice command), ‘LED light’ and ‘mercury light’ (IoT device capable of executing the voice command). Thus, the brightness can be increased by either ‘opening the window’, switching on the ‘LED light’ or switching on the ‘mercury light’. The feasibility of availing the IoT device utilizing natural alternative(s) can be checked, by the processor 103, based on the ecological factors.

For example, wherein the voice command is “turn on the AC”. The functionalities of the AC are cooling the ambience, improving the air quality, reduce moisture and humidity, and so on. In this scenario, the device detector 102 can determine that an air purifier (IoT device) is having some of the functionalities of the AC. If the user intent is to avail the functionality provided by the air purifier, then a flow can be generated, which includes the air purifier. The processor 103 can generate another flow that includes a smart window, on determining that the smart window utilizes natural alternative for executing the voice command. Opening the smart window can allow the user to avail most of the functionalities of the AC, provided the ecological factors are appropriate. The processor 103 can determine that the combination of opening the smart window (natural alternative) and switching on the air purifier (IoT device), can mimic the functionalities of the AC, thereby accomplishing the user intent. Thus, a flow can be generated, which includes a combination of the smart window and the air purifier. If it is determined, based on the ecological factors, that it is not feasible to utilize the IoT device relying on natural alternative to execute the voice command, then the AC can be turned on.

The processor 103 can monitor usage patterns of the IoT devices. Example parameters used for monitoring the usage patterns may include, but are not limited to, average operating time period, average power consumption, at least one parameter pertaining to a specific IoT device, and so on. For an AC, monitoring the usage pattern may include determining an average time period for which the AC is operated by the user, average power consumed by the AC, average temperature set by the user, location of the AC in the IoT environment, average noise level generated by the AC, and so on. For an LED light, monitoring the usage pattern involves determining an average time period for which the LED is switched on, average power consumed by the LED, average luminosity set by the user, location of the LED in the IoT environment, and so on.

The processor 103 can adjust the settings of the IoT devices, which have been determined to be capable of executing the voice command or perform the action that is specified in the voice command, as per the intent of the user. For example, where the voice command is “turn on the AC”, the AC temperature can be set based on the usage pattern of the AC. The functionalities of the AC may include, for example, cooling the ambience, improving the air quality, reduce moisture and humidity, and so on. The intent of the user can be employing at least one of the above mentioned functionalities.

The AC temperature may be set to a value, such that the user intent is accomplished. In an embodiment, the AC temperature is set based on at least one of the previous usage pattern and the ecological factors. For example, if, based on previous usage pattern, it is observed that on an average the AC temperature is set to 22° C., and the weather is chilly, the AC temperature is set to 26° C. In this scenario, considering the weather, the user intent is considered to be improving the air quality, rather than cooling the ambience.

It is noted that if the processor 103 would have determined then it was feasible to use the air purifier, open the smart window, or use the air purifier along with opening the smart window, then the processor 103 would have likely to have prompted the user to: use the air purifier (having a lower power consumption compared to the AC), open the smart window (no power consumption), or use the air purifier and open the smart window (power consumption would be lower compared to the AC).

The processor 103 may assign ranks to different flows, comprising either of IoT devices capable of executing the voice command, IoT devices utilizing natural alternative(s) for executing the voice command, or combinations of IoT devices capable of executing the voice command and IoT devices utilizing natural alternative(s) for executing the voice command. In an embodiment, the processor 103 can assign the ranks to the flows based on the amount of power consumed by the IoT devices in the different flows. The amount of power consumed by the IoT devices is determined based on previous usage patterns and power rating of the IoT devices.

In an example, for an AC, the processor 103 can obtain the power rating of the AC (amount of power that is likely to be consumed by the AC) from a server of the manufacturer of the AC. The power rating can indicate the amount of power that is likely to be consumed, if the AC is operated for 1 hour. Further, the processor 103 can determine the average time period for which the AC is operated, based on the usage pattern. The processor 103 can compute the product of the average operating time period and the power rating to obtain the amount of power that is likely to be consumed. If alternative flows have been suggested, such as air purifier, opening of the smart window, and a combination of air purifier and opening of the smart window, then the processor 103 can determine the amounts of power that is likely to be consumed for each of the flows. The flow that consumes a low amount of power is likely to be assigned a higher rank, compared to the flow that consumes a greater amount of power.

In an embodiment, the processor 103 can assign ranks to flows, which include IoT devices that utilize natural alternative(s), based on the ecological factors that are associated with the natural alternative(s) utilized by the IoT devices in the flows. The ecological factors are capable of affecting the user experience when the IoT devices utilizing the natural alternative(s), are utilized for executing the voice command. Considering the example voice command to be “turn on the AC”, the processor 103 can assign ecological indices, with value in the range 0-1, to the flows ‘smart window’, and the ‘combination of air purifier and smart window’. In an embodiment, if the values of the ecological indices corresponding to the flows, including IoT devices relying on natural alternative(s) for executing the voice command, is greater than 0.5, then the flows may not be considered as feasible.

The processor 103 may assign a rank to a flow based on at least one of power consumption involved in executing the voice command using the flow and ecological factors associated with the flow. Considering the example voice command “increase the brightness”, the flows are ‘switching on LED light’, ‘switching on mercury light’, and ‘opening the smart window’. The processor 103 can assign ranks to the respective flows based on at least one of the power consumptions the IoT devices in the flows that are involved in executing the voice command, and ecological factors affecting the feasibility of the flows including the IoT devices that utilize natural alternative(s) for executing the voice command. The processor 103 determines the power consumptions involved in executing the voice command using the LED light and mercury light, and the ecological factors associated with ‘opening the smart window’. The processor 103 can assign respective ranks to the flows based on the determined values of power consumptions and ecological indices.

The processor 103 may cause the display to display the flows in the form of a list on the display 106. The processor 103 can display, in the list, at least one of IoT devices capable of executing the voice command, IoT devices utilizing the natural alternative for executing the voice command, and combinations of IoT devices capable of executing the voice command and IoT devices utilizing natural alternative(s) for executing the voice command, based on the assigned ranks. In an embodiment, the flow assigned with the highest rank is placed on top of the list. The flow assigned with the lowest rank is placed on bottom of the list. The flows can act as options that are available to the user. The user can select one of the flows to execute the voice command.

In an embodiment, if execution of the voice command does not require an IoT device then the processor 103 can obtain information that can be used for executing the voice command. In an example, consider that the voice command is “what is the capital of India?” In this scenario, the processor 103 can fetch the information pertaining to the voice command. Once the information (Delhi) is fetched, the processor 103 can relay the information to the user.

FIG. 1 illustrates various example units of the voice assistant 100, but it is to be understood that other embodiments are not so limited. In other example embodiments, the voice assistant 100 may include less or more number of units. Further, the labels or names of the units of the voice assistant 100 are used only for illustrative purpose and does not limit the scope of the disclosure. One or more units can be combined together to perform same or substantially similar function in the voice assistant 100.

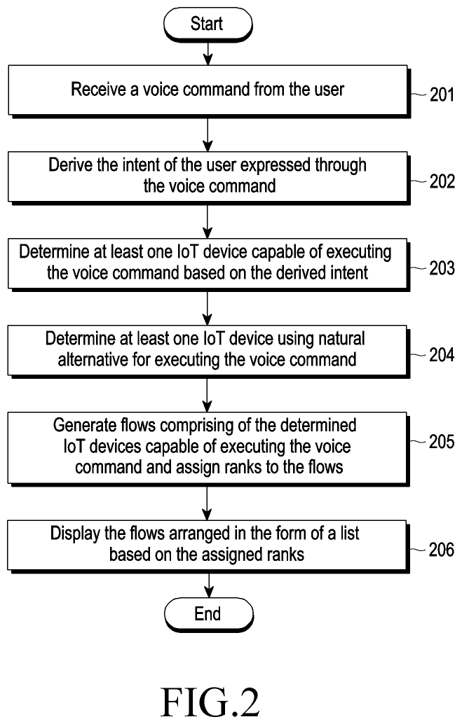

FIG. 2 is a flowchart 200 illustrating an example method for enabling the voice assistant 100 to facilitate energy efficient execution of user commands using the IoT devices in the IoT environment, according to various embodiments. At operation 201, the method includes receiving a voice command from the user.

At operation 202, the method includes deriving the intent of the user expressed through the voice command. Embodiments include determining whether the voice command had specified the action that needs to be performed and the IoT device, through which the specified action can be performed. If the action and the IoT device are specified in the voice command, the intent can be derived. On the other hand, if the action and the IoT device are not specified in the voice command, embodiments include deriving the intent of the user by deriving, from the voice command, the action that needs to be performed to execute the voice command.

At operation 203, the method includes determining at least one IoT device capable of executing the voice command based on the derived intent. If the user had specified, in the voice command, the action that needs to be performed and the IoT device, through which the specified action can be performed, embodiments include detecting at least one IoT device in the IoT environment that is capable of performing the action specified in the voice command. The detected at least one IoT device are likely to perform the action, for executing the voice command, in a more energy efficient manner compared to the IoT device specified in the voice command.

In case the intent of the user is derived by determining the action to be performed to execute the voice command, embodiments include determining at least one IoT device in the IoT environment, which is capable of performing the intended action.

The determined at least one IoT device and the IoT device specified in the voice command, if any, can be considered as flows that are available to the user, wherein the user can choose one of the flows to execute the voice command.

At operation 204, the method includes determining at least one IoT device that utilizes natural alternative(s) for executing the voice command. The at least one IoT device utilizing the natural alternative can lead to the performance of the intended action. The at least one natural alternative allows executing the voice command (performing the intended action) without the expensing energy. A combination of an IoT device capable of executing the voice command and an IoT device utilizing a natural alternative for executing the voice command can be determined, which allows executing the voice command at a minimum and/or reduced energy expense. The effect of using the at least one IoT device utilizing the natural alternative, or the combination of the IoT device capable of executing the voice command and the IoT device utilizing a natural alternative for executing the voice command, is same as or similar to the effect of utilizing the at least one IoT device (specified in the command or determined at operation 203) capable of executing the voice command.

The at least one IoT device utilizing the natural alternative can be used for executing the voice command if ecological factors support utilizing the at least one natural means for executing the voice command. The ecological factors indicate the feasibility of using the IoT device utilizing the at least one natural alternative for executing the voice command. The embodiments include obtaining the ecological factors using sensors or third-party devices through the Internet. The ecological factors considered for determining the feasibility of the at least one IoT device utilizing the natural alternative are based on the action that needs to be accomplished using the at least one IoT device utilizing the natural alternative.

In an embodiment, the feasibility of the at least one IoT device utilizing the natural alternative for executing the voice command may be defined using, for example, ecological indices. The values of the ecological indices may, for example, be in a range from 0-1, wherein 0 defines the highest feasibility and 1 defines the lowest feasibility. If the at least one IoT device utilizing the natural alternative for executing the voice command is determined to be feasible, based on the ecological indices, embodiments include generating flows that will be available to the user to execute the voice command, which include the at least one IoT device utilizing the natural alternative for executing the voice command.

In an example, the voice command issued by the user is “turn on the geyser”. The embodiments include deriving the intent of the user by determining the action to be performed. As the geyser can increase the water temperature, the embodiments include determining at least one IoT device that can is capable of performing the action of increasing the temperature of water, which is the actual intent of the user. In an example, the IoT environment includes a solar panel. The solar panel can be an alternative IoT device, which allows heating water. As the solar panel utilizes a natural alternative (solar energy) to increase the water temperature, the embodiments include determining ecological factors, based, for example, on time of the day, weather, ambient temperature, and so on. If it is determined that the solar panel is feasible for increasing the water temperature based on the ecological factors (daytime, sunny weather, ambient temperature high/mild), the solar panel is considered as an IoT device capable of executing the user command. The embodiments include generating two flows, including, for example, the solar panel and the geyser.

Example embodiments include monitoring usage patterns of the IoT devices in the IoT environment. The usage pattern of an IoT device can be obtained by determining, for example, at least one of an average of the operating time periods of an IoT device, average power consumption of the IoT device, and parameters pertaining to the IoT device, and so on. The embodiments include adjusting the settings of the IoT devices included in the flows based on the usage patterns and the ecological factors. For example, the water temperature can be set to a particular value based on values of temperatures previously set by the user, temperature of water that will be heated, and the ambient temperature.

At operation 205, the method includes generating flows and assigning ranks to the flows based on power consumption and at least one ecological factor. The power consumption of the flows can refer to the power consumption of the at least one IoT device in the flows, that are capable of executing the voice command. The at least one ecological factor is associated with at least one natural alternative, which are relied upon by at least one IoT device in the flows that utilize the at least one natural means for executing the voice command. The power consumption of the at least one IoT device capable of executing the voice command depends on previous usage patterns and power rating of the at least one IoT device. In an example, the rank can be assigned to the flow based on a product of the power rating (power consumption) of the at least one IoT device in the flow and the operating time period of the at least one IoT device in the flow. The operating time period of the at least one IoT device in the flow can be obtained from the previous usage pattern. The assigned rank may be inversely proportional to the value of the product.

Embodiments include assigning the ranks to the at least one flow, including at least one IoT device utilizing natural means for executing the voice command, based on the at least one ecological index associated with the at least one natural means. If the value of the at least one ecological index is 0 or close to 0, the assigned rank will be high. If the value of the at least one ecological index is 1 or close to 1, the assigned rank will be low.

At operation 206, the method includes displaying the at least one flows, arranged in the form of a list, wherein the arrangement is based on the assigned ranks. Example embodiments include displaying at least one of: the at least one IoT device that has been determined to be capable of executing the voice command, the at least one IoT device utilizing natural means, which has been determined to be capable of executing the voice command, and the combination of at least one IoT device capable of executing the voice command and at least one IoT device utilizing natural alternative(s) for executing the voice command, in the list, in a descending order based on the assigned ranks. The user can select the IoT device (if specified in the voice command), the at least one IoT device capable of executing the voice command, the at least one IoT device utilizing natural alternative(s) for executing the voice command, and the at least one combination of IoT device capable of executing the voice command and the at least one IoT device utilizing natural alternative(s) to execute the user command.

The various actions in the flowchart 200 may be performed in the order presented, in a different order, or simultaneously. Further, in various example embodiments, some actions listed in FIG. 2 may be omitted.

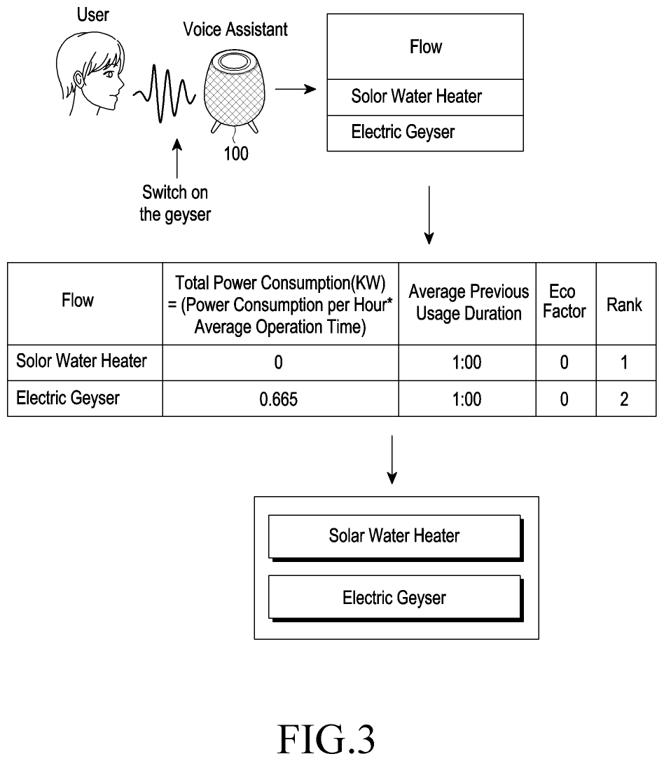

FIG. 3 is a diagram illustrating an example use-case scenario illustrating the generation of flows for providing alternatives to a user for obtaining hot water, according to various embodiments. For example the voice command issued by the user is “switch on the geyser”. The embodiments include deriving the intent of the user on receiving the voice command. The voice command specifies the IoT device, e.g., geyser, and the action to be performed (switch on the geyser). Based on the voice command, the embodiments include obtaining the functionalities of the geyser. One of the functions of the geyser is to increase the temperature of water (heat water). The embodiments include determining at least one IoT device in the IoT environment that can increase the water temperature.

For example, the determined at least one IoT device in the IoT environment, capable of performing the action of increasing the water temperature, is a solar panel. The embodiments include determining the feasibility of the solar panel for increasing the water temperature, based on at least one ecological factor, e.g., time of the day, weather, ambient temperature, and so on. This is because the solar panel utilizes solar energy to increase the water temperature. If it is determined that the solar panel is feasible for increasing the water temperature, based on the ecological factors, the solar panel is considered as an IoT device that is capable of executing the user command. The solar panel can be one of the flows, along with the geyser. The embodiments include generating two flows, e.g., the solar panel and the geyser.

Example embodiments include obtaining the flow metrics that indicates the ranks assigned to the flows. In an embodiment, the total power that each flow is likely to consume, if the flow is used for heating water (increasing the water temperature), is based on the power ratings and previous usage patterns of the IoT devices in the flows. The embodiments include determining the power consumption based on the previous operating time periods of the geyser and the solar panel and the individual power ratings of the geyser and the solar panel. The embodiments include determining the ecological index of the solar panel (the geyser, being an IoT device and independent of ecological factors, is not having any relevance to the ecological index). The ranks can be assigned to the geyser and the solar panel based on at least one of the ecological factors and the power consumptions of the geyser and the solar panel.

As the power consumption involved in heating water using the solar panel is zero, compared to 665 W involved in heating water using of the geyser, the solar panel is ranked higher than the geyser. The embodiments include displaying the flows, wherein the solar water heater is displayed as the top option, followed by the geyser. The user can select any one of the flows for heating water. In case the user intends to heat water while incurring less power, the user is likely to select the solar water heater to heat the water.

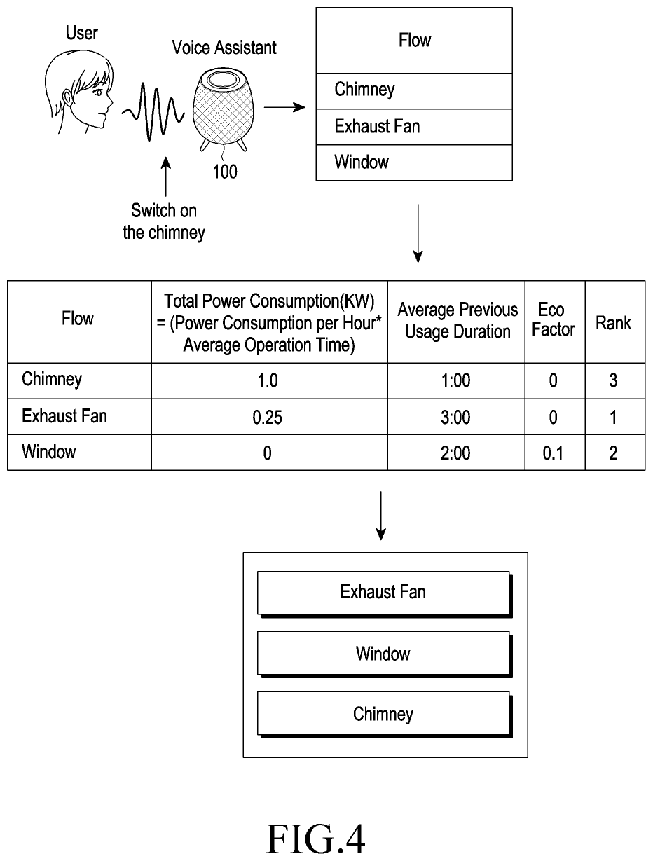

FIG. 4 is a diagram illustrating an example use-case scenario illustrating generation of flows for providing alternatives to a user for venting smoke from a kitchen, according to various embodiments. For example, the voice command issued by the user is “switch on the chimney”. Example embodiments include deriving the intent of the user on receiving the voice command. The voice command specifies the IoT device, e.g., chimney, and the action to be performed (turn on the chimney). Based on the voice command, the embodiments include obtaining the functionalities of the chimney. One of the functions of the chimney is to remove smoke or other unwanted particles present in the air. The embodiments include determining at least one IoT device in the IoT environment that can remove the smoke.

Consider that an IoT device and an IoT device utilizing a natural means is determined in the IoT environment (kitchen), which are capable of performing the action of removing the smoke. The determined IoT device is an exhaust fan and the IoT device utilizing natural means is the smart window. The embodiments include determining the feasibility of opening the smart window for removing the smoke, based on air quality of the ambience of the kitchen. This is because if the air quality of the ambience is poor, it may not be feasible to open the smart window for removing the smoke. If it is determined that the opening the smart window is feasible for removing the smoke, the smart window is considered as a flow, that is capable of executing the voice command. The exhaust fan can be one of the flows, along with the chimney. The embodiments include generating three flows, e.g., the chimney, smart window, and the exhaust fan.

Example embodiments include obtaining the flow metrics, which indicate the ranks assigned to the flows. In an embodiment, the total power that each flow is likely to consume, if the flow is used for removing the smoke, is based on usage patterns and power ratings of the IoT devices included in the flows. The embodiments include determining the power consumption based on the previous operating time periods of the chimney and the exhaust fan and the individual power ratings of the chimney and the exhaust fan. The embodiments include determining the ecological index of opening the smart window (the chimney and the exhaust fan, being IoT devices and independent of ecological factors, the value of their individual ecological indices is 0). Based on the air quality of the ambience of the kitchen, the value of ecological index associated with opening the smart window is determined to be 0.1. The ranks can be assigned to the chimney, opening the smart window, and the exhaust fan, based on at least one of the ecological factors and the power consumptions of the chimney and the exhaust fan.

The power consumption involved in using the exhaust fan, for removing the smoke, is, for example, 250 W. The power consumption involved in using the chimney, for removing the smoke, is 1000 W. As the power consumption of the exhaust fan is lower than that of the chimney, the exhaust fan is ranked higher than the chimney. There is no power consumption involved in removing the smoke by opening the smart window. As the ecological index associated with opening the smart window is 0.1, the natural alternative of opening the smart window is ranked lower than the exhaust fan. Further, if the user had previously preferred to use the exhaust fan, then opening the smart window, the exhaust fan can be ranked higher than the natural means of opening the smart window. However, as no power is consumed in opening the smart window, opening the smart window is ranked higher than the chimney. The embodiments include displaying the flows, wherein the exhaust fan is ranked 1^{st} and placed as the top of the list, followed by opening the smart window (ranked 2^{nd}) and the chimney (ranked 3^{rd}). The user can select one of the flows for removing the smoke.

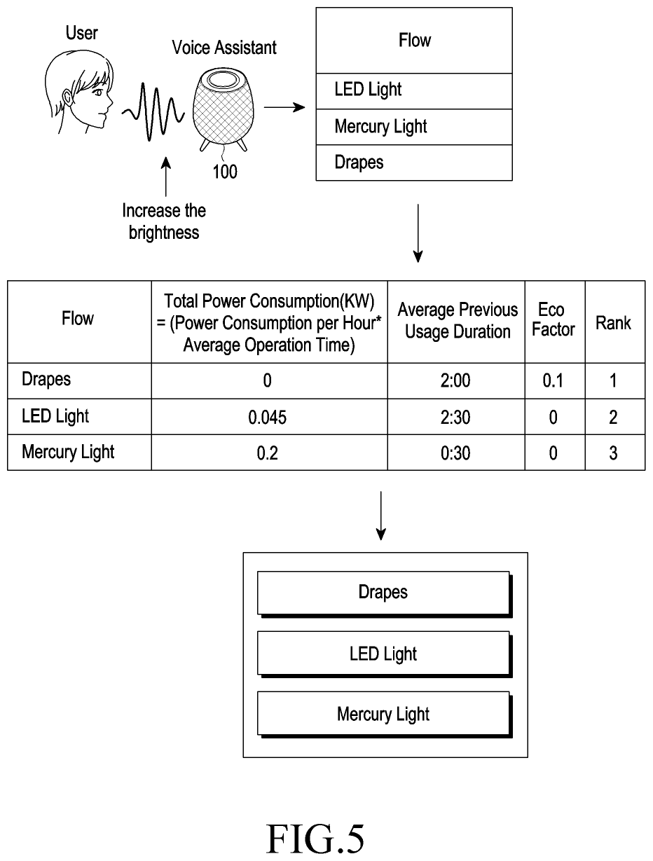

FIG. 5 is a diagram illustrating an example use-case scenario illustrating the generation of flows for providing alternatives to a user for increasing the brightness of a room, according to various embodiments. For example, the voice command issued by the user is “increase the brightness”. The embodiments include deriving the intent of the user on receiving the voice command. The voice command does not specify any IoT device. Therefore, the embodiments include determining the action, which, if performed, can fulfill the intent of the user. The embodiments include determining that the action is to lighting up the room. The embodiments include determining at least one IoT device in the IoT environment that can light up the room.

For example, an IoT device and an IoT device utilizing a natural alternative is determined in the IoT environment (kitchen), which are capable of performing the action of increasing the brightness. The determined IoT devices are an LED light and a mercury light, and an IoT device drapes (smart window) that utilizes natural means for lighting up the room. The embodiments include determining the feasibility of opening the smart window for lighting up the room, based on air quality of the ambience, the weather, and sunshine. This is because if the air quality of the ambience is poor, the temperature is high, and the weather is humid, it may not be feasible to open the smart window for lighting up the room. If it is determined that the opening the smart window is feasible for lighting up the room, the smart window is considered as a flow, that is capable of executing the voice command. The embodiments include generating three flows, e.g., the LED light, mercury light, and the smart window.

The embodiments include obtaining the flow metrics, which indicate the ranks assigned to the flows. In an embodiment, the total power that each flow is likely to consume, if the flow is used for lighting up the room, is based on usage patterns and power ratings of the IoT devices included in the flows. The embodiments include determining the power consumption based on the previous operating time periods of the LED light and the mercury light and the individual power ratings of the LED light and the mercury light. The embodiments include determining the ecological index of opening the smart window (the LED light and the mercury light, being IoT devices and independent of ecological factors, the value of their individual ecological indices is 0). Based on the air quality of the ambience, weather, temperature, and so on, the value of ecological index associated with opening the smart window is determined to be 0.1. The ranks can be assigned to the LED light, opening the smart window, and the mercury light, based on at least one of the ecological factors and the power consumptions of the LED light and the mercury light.

The power consumption involved in using the LED light, for lighting up the room, is lower than that of the mercury light. Therefore, the LED light is ranked higher than the mercury light. There is no power consumption involved in lighting up the room by opening the smart window. As the ecological index associated with opening the smart window is 0.1, lighting up the room using the natural alternative of opening the smart window is ranked higher than the LED light and the mercury light. The embodiments include displaying the flows, wherein the drapes (smart window) is ranked 1^{st} and placed as the top of the list, followed by the LED light (ranked 2^{nd}) and the mercury light (ranked 3^{rd}). The user can select one of the flows for lighting up the room.

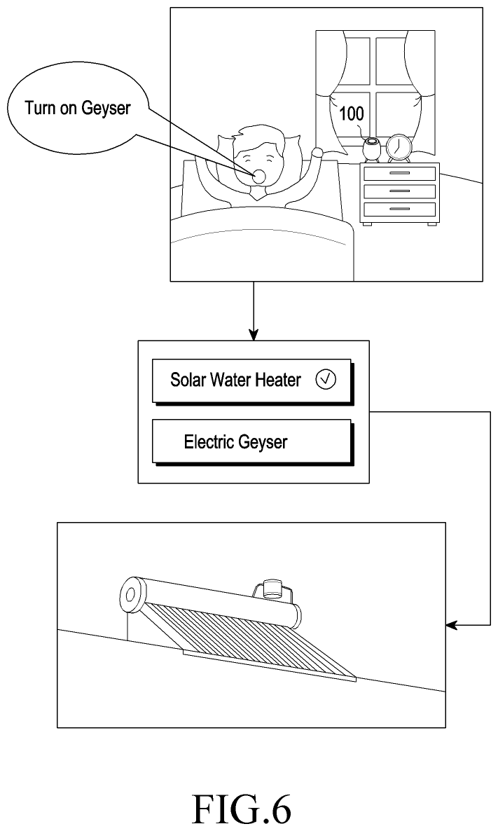

FIG. 6 is a diagram illustrating example selection of solar water heater by the user for obtaining hot water, according to various embodiments. As illustrated in FIG. 6, the user can issue a voice command “turn on geyser”, after waking up. The voice command can be picked-up by the voice assistant 100. The voice assistant 100 can derive the intent of the user from the voice command. The intent is derived as the user wants to obtain hot water. The voice assistant 100 can determine the availability of flows (IoT devices) that can be used for executing the received voice command, e.g., obtain hot water. The voice assistant 100 can determine that apart from the geyser, a solar water heater can also generate hot water. The voice assistant 100 can assign ranks to the geyser and the solar water heater, based on power consumption of the geyser and the solar water heater, and the ecological index. The ecological index indicates the feasibility of utilizing the solar water heater to obtain hot water. For example, the weather is sunny and the time of the day is close to noon. Therefore, using the solar water heater is feasible for obtaining water. Further, the power consumption involved in obtaining hot water using the geyser is more than the solar water heater. Therefore, the voice assistant 100 ranks the solar water heater above the geyser. The solar water heater and the geyser are displayed. As the solar water heater is ranked higher, the user selects the solar water heater for obtaining hot water.

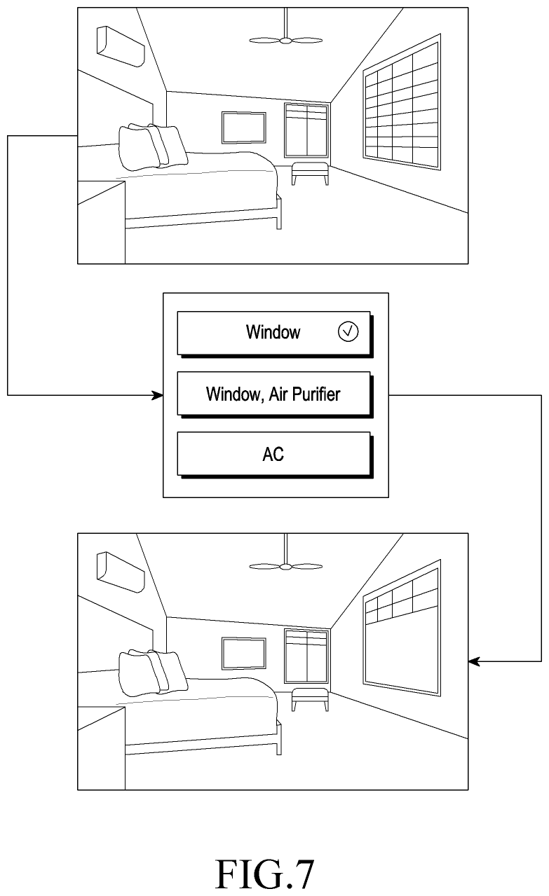

FIG. 7 is a diagram illustrating example selection of smart window for improving air quality of a room, according to various embodiments. As illustrated in FIG. 7, the air quality of the room is not optimal. The user can issue a voice command “turn on the AC”. The voice command is picked-up by the voice assistant 100. The voice assistant 100 can derive the intent of the user from the voice command, which is to improve the air quality of the room. The voice assistant 100 can determine the availability of IoT devices that can be used for improving air quality of the room. The voice assistant 100 can determine that apart from the AC (IoT device), a smart window (IoT device which uses a natural alternative for improving the air quality), and a combination of an air purifier (IoT device) and the smart window (IoT device which uses a natural alternative for improving the air quality), can be used for executing the user command. The voice assistant 100 can assign ranks to the AC, the combination of the air purifier and the smart window, and the smart window. The ranking may be based on power consumption of the AC and the air purifier, and the ecological index, which indicates feasibility of opening the smart window to optimize and/or improve the air quality of the room. For example, the weather is sunny and the quality of the air outside the room is optimal. As the air purifier consumes power, opening the smart window, for optimizing and/or improving the air quality of the room, is more feasible, compared to using the combination of opening the window and switching the air purifier. Therefore, the voice assistant 100 ranks the window highest, followed by the combination of the smart window and the air purifier. Further, the power consumption of the AC is greater than the air purifier. Therefore, the voice assistant 100 ranks the AC lower than the combination of the smart window and the air purifier. As the smart window is ranked highest, the user selects the smart window for improving the air quality of the room.

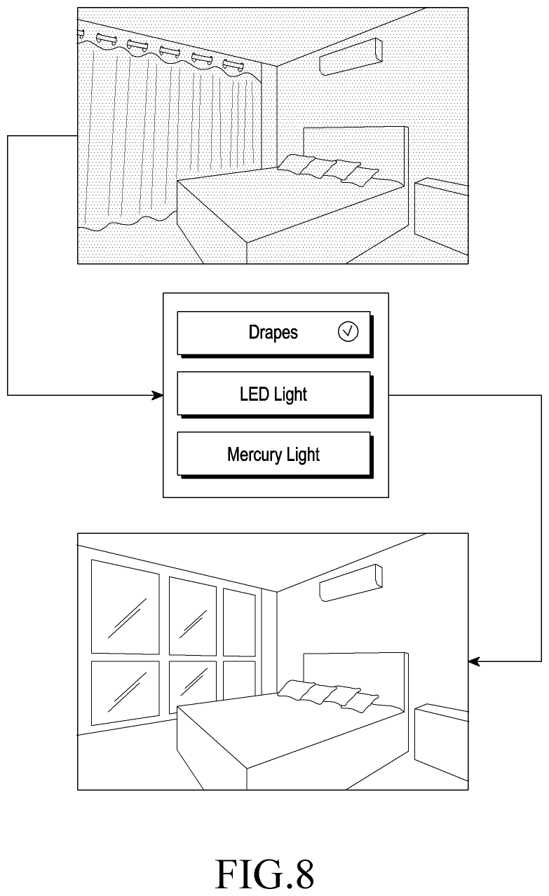

FIG. 8 is a diagram illustrating example selection of drapes for increasing the brightness of a room, according to various embodiments. As illustrated in FIG. 8, the room is dark. The user can issue a voice command “increase the brightness”. The voice command is picked-up by the voice assistant 100. The voice assistant 100 can determine the availability of IoT devices that can be used for increasing the brightness of the room (e.g., lighting the room). The voice assistant 100 can determine an LED light (IoT device), a mercury light (IoT device), and the drapes (IoT device which uses a natural alternative for increasing the brightness), which can be used for executing the user command. The voice assistant 100 can assign ranks to the LED light, the mercury light, and the drapes. The ranking is based on power consumption of the LED light and the mercury light, and the ecological index, indicating feasibility of opening the drapes to increase the brightness of the room. For example, opening the drapes is feasible for increasing the brightness of the room. As there is no power consumption involved in opening the drapes, the voice assistant 100 ranks the drapes highest, followed by the LED light and the mercury light. Further, the power consumption of the mercury light is greater than the LED light. Therefore, the voice assistant 100 ranks the mercury light lower than the LED light. As the drapes' is ranked highest, the user can select the drapes for increasing the brightness of the room.

The various example embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The various example embodiments disclosed herein describe methods and systems for enabling a voice assistant to facilitate execution of user commands in an IoT environment using IoT devices, wherein the execution allows efficient utilization of energy and resources for executing the user commands and providing an enhanced user experience. Therefore, it is understood that the scope of the protection is extended to such a program and in addition to a non-transitory computer readable medium having a instructions recorded thereon, such computer readable storage media contain program code for implementation of one or more steps of the method, when the program runs on a server or mobile device or any suitable programmable device. The method may, for example, be implemented in an example embodiment through or together with a software program written, for example, in Very high speed integrated circuit Hardware Description Language (VHDL), or any other programming language, or implemented by one or more VHDL or several software modules being executed on at least one hardware device. The hardware device can be any kind of portable device that can be programmed. The device may also include various types, which could include, for example, a hardware device, for example, an Application-specific Integrated Circuit (ASIC), or a combination of hardware and software, for example, an ASIC and a Field Programmable Gate Array (FPGA), or at least one microprocessor and at least one memory with software modules located therein. The example methods disclosed herein could be implemented partly in hardware and partly in software. Various example embodiments of the disclosure may be implemented on different hardware devices, e.g. using a plurality of Central Processing Units (CPUs).

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents.

What is claimed is:

1. A method for executing voice commands in an Internet of Things (IoT) environment, the method comprising:
determining, by a voice assistant, availability of a plurality of execution flows for executing a received voice command;
assigning, by the voice assistant, ranks to each of the plurality of execution flows based on at least one of: at least one power consumption of at least one IoT device in each of the plurality of execution flows, and at least one ecological index; and
recommending, by the voice assistant, the plurality of execution flows for executing the received voice command based on the assigned ranks.

2. The method, of claim 1, wherein each of the plurality of execution flows includes at least one IoT device capable of executing the received voice command, and wherein the at least one IoT device in each of the plurality of execution flows, is determined to possess capability of performing at least one action, wherein the at least one action is determined based on the intent of a user derived from the received voice command.

3. The method, of claim 1, wherein the power consumption of the at least one IoT device in each of the plurality of execution flows is determined based on at least one derived usage pattern of the at least one IoT device and at least one power rating of the at least one IoT device.

4. The method, of claim 1, wherein a feasibility of using the at least one IoT device in each of the plurality of execution flows to execute the received voice command is determined based on the at least one IoT device utilizing a natural alternative to execute the received voice command.

5. The method, of claim 4, wherein the at least one ecological index corresponding to the at least one IoT device in each of the plurality of execution flows is determined based on at least one ambient factor influencing the feasibility of utilizing the at least one IoT device to execute the voice command.

6. The method, of claim 3, wherein at least one setting of the at least one IoT device, included in each of the plurality of execution flows, is adjusted based on at least one of the derived usage pattern of the at least one IoT device and at least one ambient factor.

7. The method, of claim 1, wherein the method further comprises receiving an input from the user, wherein the input indicates selection of an execution flow among the recommended plurality of execution flows, to execute the received voice command.

8. A method for energy efficient execution of voice commands in an Internet of Things (IoT) environment, the method comprising
receiving, by a voice assistant, a voice command from a user;
determining, by the voice assistant, an intent of the user based on the received voice command;
identifying, by the voice assistant, at least one IoT device capable of executing the voice command based on the determined intent;
predicting, by the voice assistant, at least one execution metric associated with each of the at least one IoT device for executing the received voice command; and
selecting, by the voice assistant, an IoT device from among the identified at least one IoT device for executing the voice command based on the predicted at least one execution metric.

9. The method, of claim 8, wherein the at least one execution metric comprises a power consumption requirement of the at least one IoT device and an ecological index indicating a feasibility of utilizing the at least one IoT device.

10. The method, of claim 9, wherein the power consumption of the at least one IoT device in each of the plurality of execution flows is determined based on at least one of derived usage pattern of the at least one IoT device and at least one power rating of the at least one IoT device.

11. The method, of claim 9, wherein the ecological index is determined based on the at least one IoT device utilizing a natural alternative to execute the received voice command, wherein the ecological index is determined based on at least one ambient factor influencing the feasibility of utilizing the at least one IoT device to execute the voice command.

12. The method, of claim 9, wherein the power consumption requirement of the selected IoT device is lowest among the identified at least one IoT device.

13. The method, as claimed in claim 9, wherein the voice command includes an action to be executed by at least one device in the IoT environment

14. A voice assistant configured to execute voice commands in an Internet of Things (IoT) environment, the voice assistant comprising:
a transceiver including circuitry configured to transmit and receive a signal; and
a processor configured to:
determine availability of a plurality of execution flows for executing a received voice command;
assign ranks to each of the plurality of execution flows based on at least one of: at least one power consumption of at least one IoT device in each of the plurality of execution flows, and at least one ecological index; and
recommend the plurality of execution flows for executing the received voice command based on the assigned ranks.

15. The voice assistant of claim 14, wherein each of the plurality of execution flows includes at least one IoT device capable of executing the received voice command, and wherein the at least one IoT device in each of the plurality of execution flow, is determined to possess a capability of performing at least one action, wherein the at least one action is determined based on an intent derived from the received voice command.

16. The voice assistant of claim 14, wherein the power consumption of the at least one IoT device in each of the plurality of execution flows is determined based on at least one derived usage pattern of the at least one IoT device and at least one power rating of the at least one IoT device.

17. The voice assistant of claim 14, wherein a feasibility of using the at least one IoT device in each of the plurality of execution flows to execute the received voice command is determined based on the at least one IoT device utilizing a natural alternative to execute the received voice command.

18. The voice assistant of claim 16, wherein the at least one ecological index corresponding to the at least one IoT device in each of the plurality of execution flows is determined based on at least one ambient factor influencing the feasibility of utilizing the at least one IoT device to execute the voice command.

19. The voice assistant of claim 15, wherein at least one setting of the at least one IoT device included in each of the plurality of execution flows, is adjusted based on at least one of the derived usage pattern of the at least one IoT device and at least one ambient factor.

20. The voice assistant of claim 14, wherein the voice assistant is further configured to receive an input, wherein the input indicates selection of an execution flow among the recommended plurality of execution flows, to execute the received voice command.
